(19) United States
(12) Patent Application Publication
(10) Pub. No.: US 2023/0363979 A1
(43) Pub. Date: Nov. 16, 2023

(54) MEDICINE DISPENSER APPARATUS

(71) Applicant: Jeff Barden, Farmington, MN (US)

(72) Inventor: Jeff Barden, Farmington, MN (US)

(21) Appl. No.: 18/195,201

(22) Filed: May 9, 2023

Related U.S. Application Data
(60) Provisional application No. 63/340,290, filed on May 10, 2022.

(51) Int. Cl. A61J 7/00; B65D 41/04; B65D 41/26

(52) U.S. Cl. CPC A61J 7/0046; B65D 41/04; B65D 41/26; A63H 3/005

(57) ABSTRACT

A medicine dispenser apparatus provided in the form of a cup defining an interior volume for dispensing medicine, the outer circumferential surface having structural components configured in a toy-like figure appearance for children to associate medicine in a positive manner and alleviate negative connotations of dispensing medicine.

### CROSS-REFERENCE TO RELATED APPLICATION

The present application claims the benefit of U.S. Provisional Application No. 63/340,290, filed May 10, 2022, which is hereby incorporated herein in its entirety by reference.

### TECHNICAL FIELD

The present invention generally relates to a medicine dispenser having one or more toy-like features, in particular a medicine dispenser that can be in the form of a cap for a medicine bottle, measuring cup, or sealed measuring cup, and the one or more toy-like features being in the form of an animal, car, doll or the like.

### BACKGROUND

It can often be a difficult task to get children to take medicine. Most young children, including infants, have an aversion to taking medicine. Common reasons for children not taking medicine include the child not understanding why the medicine is necessary, the child not liking the taste or texture, some forms of medicine being difficult to swallow, and/or the experience of taking medicine can be unpleasant or scary.

While talking the situation through may work with an older child, younger children may still not understand, and reassurances may not alleviate a child's concern. Other techniques in giving medicine may include role playing, crushing capsules or tablets and placing in other foods, establishing a routine, not overwhelming the child and involving only one person, giving the child some choices to get cooperation, rewarding the child, finding out the preferred way a child prefers to take medicine, including location (i.e., on a parent's knee, on the sofa, in bed, etc.) and with a preferred method of dispensing (i.e., spoon, syringe, dropper, drinking from cup or straw, etc.).

Various apparatus and methods have been employed to alleviate a child's concern in dispensing medicine. U.S. Pat. No. 4,79,344 discloses a toy figure member having a handle receiving for receiving therethrough the handle of a spoon. U.S. Pat. No. 4,976,646 discloses a liquid medicine spoon-like dispenser whereby the dispenser acts as a lower jaw of a toy figure. U.S. Patent Publication No. 2004/0081943 A1 discloses a puppet with a medicine dispenser, such as a syringe or spoon-like dispenser. U.S. Design Pat. No. 274,971 discloses a design of a fish with a liquid medicine spoon-like dispenser. U.S. Pat. 10,413,103 discloses a device transformable between a toy, such as a vehicle, and an eating utensil, such as a spoon or fork. The foregoing devices may alleviate some concerns for children, but most are directed to spoon-like dispensers and/or syringes.

Since children have an aversion to taking medicine, including liquid medicine that can be over the counter or prescribed, a need still exists to provide a medicine dispenser apparatus that alleviates a child's concerns or makes the experience less frightening. There is also a need for a medicine dispenser apparatus that in some situations can be provided with the bottle of liquid medicine. There is also a need for a medicine dispenser apparatus that can be reusable and/or easy to wash. There still further is a need for a medicine dispenser apparatus that is universal for various liquid medicines, cost-effective, and has a toy-like appearance to a child.

### SUMMARY

The present disclosure is generally directed to a medicine dispenser apparatus having a configuration of a cup with an interior volume that can hold at least one dose of medicine, preferably a liquid medicine, and the medicine dispenser apparatus having a toy-like figure appearance on the outer circumference of the cup, wherein the cup with the toy-like figure appearance functions to alleviate a child's concern or otherwise makes the experience less frightening.

In some preferred aspects, the medicine dispenser apparatus has threads on at least a portion of the internal circumference of the cup, such that the medicine dispenser apparatus can also function as a cap for a liquid medicine bottle.

In some preferred aspects, the medicine dispenser apparatus has at least one dosing indication, such as a line on the internal circumference of the cup. In some aspects, the dosing indication may contain written words indicating the dosing amount or volume of the dosing indication.

In some preferred aspects, the medicine dispenser apparatus has threads on at least a portion of the internal circumference of the cup and at least one dosing indication, such as a line on the internal circumference of the cup.

In some preferred aspects, the medicine dispenser apparatus contains a sealed dose of medicine within the interior volume of the cup, preferably liquid medicine, wherein the medicine is sealed within the interior volume of the cup by a seal on the top peripheral edge of the cup. In some aspects, at least a portion of the seal overlaps the top peripheral edge of the cup, such that a user can peal the seal from the top peripheral edge of the cup during dispensing of the medicine.

In some preferred aspects, the medicine dispenser apparatus contains a sealed dose of medicine within the interior volume of the cup, preferably liquid medicine, wherein the medicine is sealed within the interior volume of the cup by a seal on the top peripheral edge of the cup, wherein the seal contains a tab portion that is not sealed to the top peripheral edge of the cup, such that a user can employ the tab portion to peal the seal from the top peripheral edge of the cup during dispensing of the medicine.

In some other preferred aspects, the medicine dispenser apparatus has an interior volume of the cup that is capable of receiving a separate medicine cup, such that the medicine cup can contain the medicine, preferably liquid medicine. In some aspects, the medicine cup can be operably inserted into and/or removed from the interior volume of the cup.

In some preferred aspects, the medicine dispenser apparatus comprises one or more structural components proximately locate the outer circumference of the apparatus to providing a toy-like configuration. In some aspects, the one or more structural components providing for a trait of an animal, which can include one or more of a face-like appearance of an animal, a tail-like appearance of an animal, an ear-like appearance of an animal, a feet-like appearance of an animal, a fin-like appearance of an animal, a wing-like appearance of an animal, a leg-like appearance of an animal and an arm-like appearance of an animal.

In some preferred aspects, the structural components provide one or more eyes of the face-like appearance of the animal.

In some preferred aspects, the one or more structural components provide for a nose, beak, snout, mouth or the like of the face-like appearance of the animal.

In some preferred aspects, the one or more structural components provide for a tail for the tail-like appearance of the animal.

In some preferred aspects, the one or more structural components provide for at least one ear for an ear-like appearance of an animal.

In some preferred aspects, the one or more structural components provide for at least one foot for a feet-like appearance of an animal.

In some preferred aspects, the one or more structural components provide for a fin, a wing, a leg or an arm for a fin-like appearance, a wing-like appearance, a leg-like appearance or an arm-like appearance, respectively, of an animal.

The present disclosure is also directed at a method of dispensing medicine, preferably liquid medicine, to a person, preferably a child, utilizing the medicine dispenser apparatus disclosed herein. In some aspects, the method comprises providing the medicine dispenser apparatus having a toy-like appearance, dispensing medicine into an inner volume of the apparatus, and dispending medicine out of the inner volume of the apparatus to a human, preferably the human being a child.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIGS. 1A and 1B are a front prospective view and a back prospective view, respectively, of a medicine dispenser apparatus having a toy-like figure appearance of a bird on the outer circumference of the cup, according to certain embodiments of the present invention;

FIG. 2 show is a side prospective view a medicine dispenser apparatus having a toy-like figure appearance of a rabbit on the outer circumference of the cup, according to certain embodiments of the present invention;

FIG. 3 is a front perspective view of a medicine dispenser apparatus having a toy-like figure appearance of a cat on the outer circumference of the cup, according to certain embodiments of the present invention;

FIG. 4 is a front perspective view of a medicine dispenser apparatus having a toy-like figure appearance of a dinosaur on the outer circumference of the cup, according to certain embodiments of the present invention;

FIG. 5 is a front perspective view of a medicine dispenser apparatus having a toy-like figure appearance of a dog on the outer circumference of the cup, according to certain embodiments of the present invention;

FIG. 6 is a front perspective view of a medicine dispenser apparatus having a toy-like figure appearance of a duck on the outer circumference of the cup, according to certain embodiments of the present invention;

FIG. 7 is a front perspective view of a medicine dispenser apparatus having a toy-like figure appearance of a monkey on the outer circumference of the cup and the top preferable edge having a tab receiving portion, according to certain embodiments of the present invention;

FIG. 8 is a front perspective view of a medicine dispenser apparatus having a toy-like figure appearance of a monkey on the outer circumference of the cup, according to certain embodiments of the present invention;

FIG. 9 is a front perspective view of a medicine dispenser apparatus having a toy-like figure appearance of a mouse on the outer circumference of the cup, according to certain embodiments of the present invention;

FIG. 10 is a front perspective view of a medicine dispenser apparatus having a toy-like figure appearance of a penguin on the outer circumference of the cup, according to certain embodiments of the present invention;

FIG. 11 is a front perspective view of a medicine dispenser apparatus having a toy-like figure appearance of a pig on the outer circumference of the cup, according to certain embodiments of the present invention;

FIG. 12 is a front perspective view of a medicine dispenser apparatus having a toy-like figure appearance of a shark on the outer circumference of the cup, according to certain embodiments of the present invention;

FIG. 13 is a front perspective view of a medicine dispenser apparatus having a toy-like figure appearance of an octopus on the outer circumference of the cup, according to certain embodiments of the present invention;

FIG. 14A shows a medicine dispenser apparatus engaged with a container as a cap, such as a cap for a bottle of medicine, according to certain embodiments of the present invention;

FIG. 14B shows the medicine dispenser apparatus of FIG. 14A disengaged from the container and at least a portion of the internal circumference of the cup having threads for operably engaging with the container, according to certain embodiments of the present invention;

FIG. 15 shows a medicine dispenser apparatus having at least one dosing indication in the form of a line on the internal circumference of the cup, according to certain embodiments of the present invention;

FIG. 16 shows a medicine dispenser apparatus having a dosing indication in the form of a line and written word, according to certain embodiments of the present invention;

FIG. 17 shows a medicine dispenser apparatus having at least one dosing indication in the form of a line on the internal circumference of the cup, and the internal circumference of the cup having threads for operably engaging with a container, according to certain embodiments of the present invention;

FIG. 18 shows a medicine dispenser apparatus having at least one dosing indication in the form of a top line of threads on the internal circumference of the cup, wherein the threads on the internal circumference of the cup capable of operably engaging with a container, according to certain embodiments of the present invention;

FIG. 19A shows a medicine dispenser apparatus containing a sealed dose of medicine within the interior volume of the cup, wherein the medicine is sealed within the interior volume of the cup by a seal proximately located on the top peripheral edge of the cup, according to certain embodiments of the present invention;

FIG. 19B shows the medicine dispenser apparatus of FIG. 19A with the seal removed from the top peripheral edge of the cup, according to certain embodiments of the present invention;

FIGS. 20A-20B show a medicine dispenser apparatus containing a sealed dose of medicine within the interior volume of the cup, wherein the medicine is sealed within the interior volume of the cup by a seal proximately located on the top peripheral edge of the cup, wherein the seal contains a tab portion for operably removing the seal, according to certain embodiments of the present invention;

FIG. 20C shows the medicine dispenser apparatus of FIGS. 20A-20B with the seal removed from the top peripheral edge of the cup, according to certain embodiments of the present invention;

FIG. 21A shows a medicine dispenser apparatus capable having a cup with an interior volume, the interior volume capable of operably receiving a secondary medicine cup, according to certain embodiments of the present invention; and

FIG. 21B shows the secondary medicine cup operably receiving within the interior volume of the cup of the medicine dispenser apparatus of FIG. 21A, according to certain embodiments of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

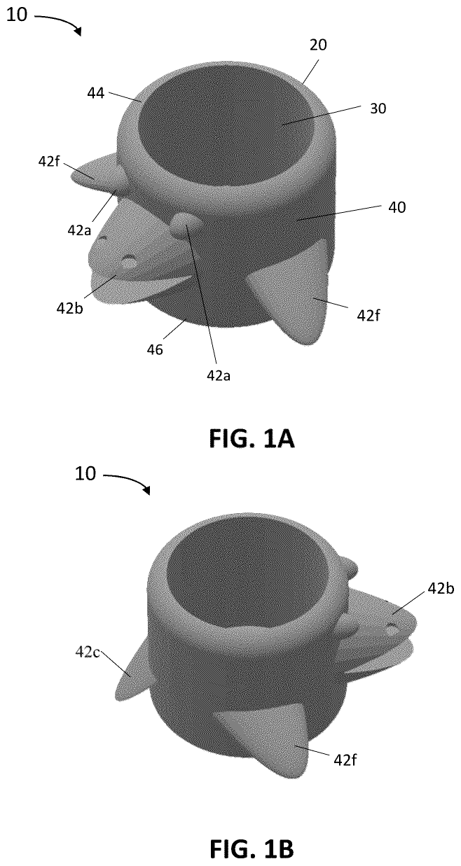

Referring generally to FIGS. 1-21, the present disclosure is generally directed to a medicine dispenser apparatus 10 in the form of a cup 20 having an interior volume 30 capable of holding a material and an outer circumferential surface 40 having at least one structural component 42 configured in a toy-like figure appearance. The interior volume 30 preferable capable of holding a liquid, more preferably a liquid medicine, such that the toy-like figure appearance functions to alleviate a person's concern or otherwise makes the experience of dispensing the material, such as liquid medicine, less frightening to the person, preferably to a child.

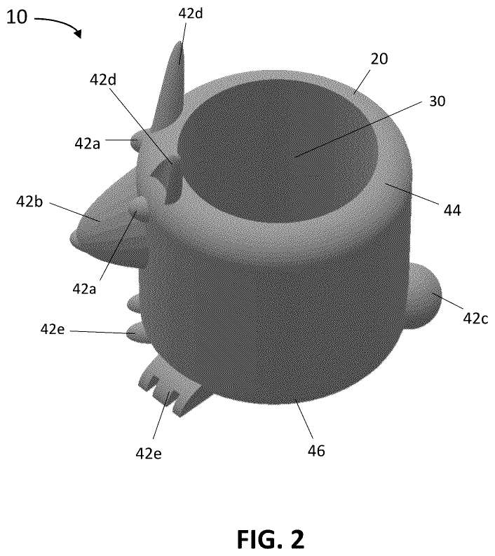

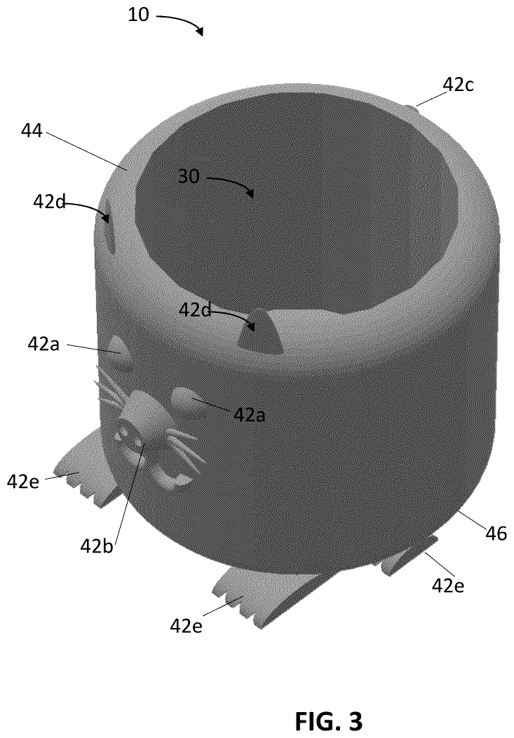

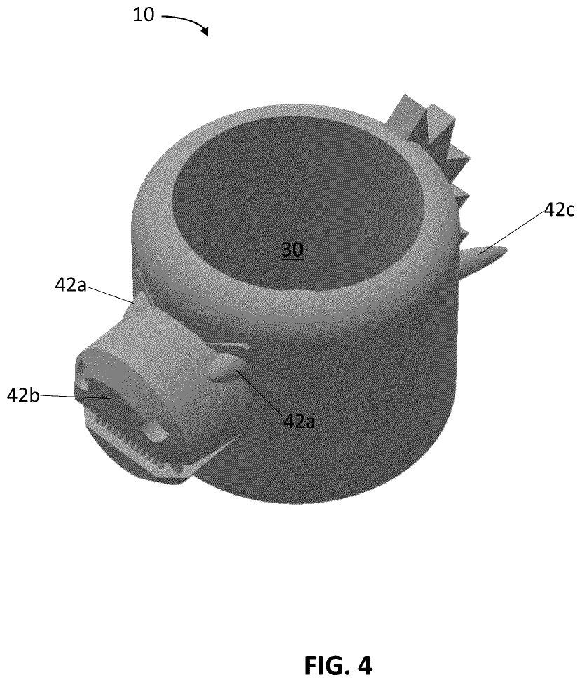

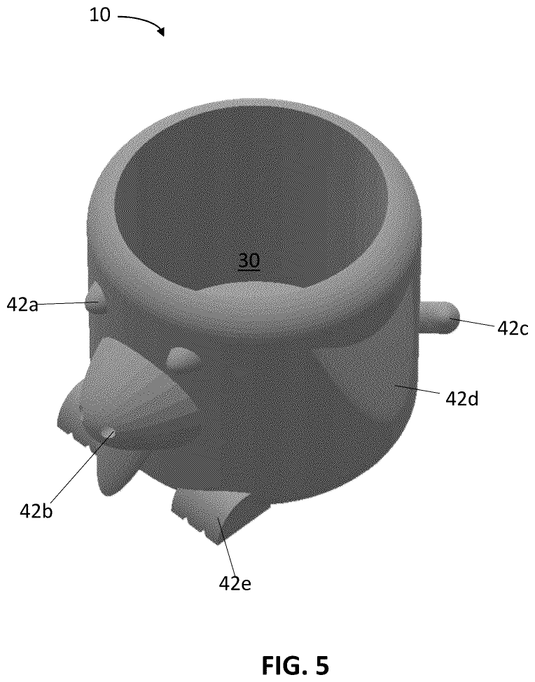

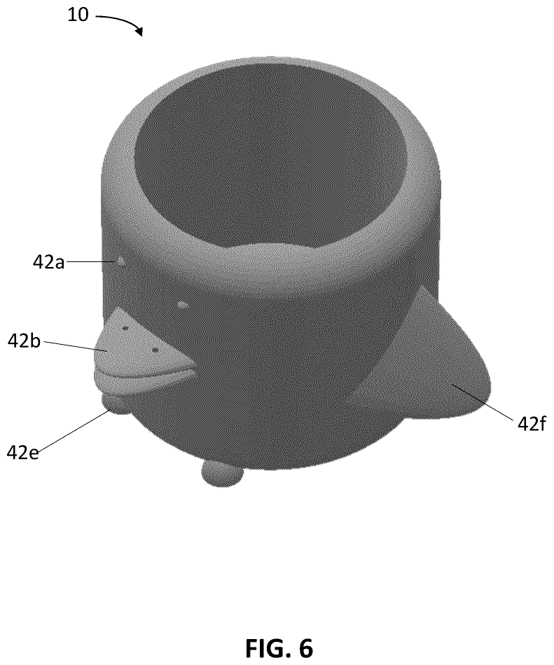

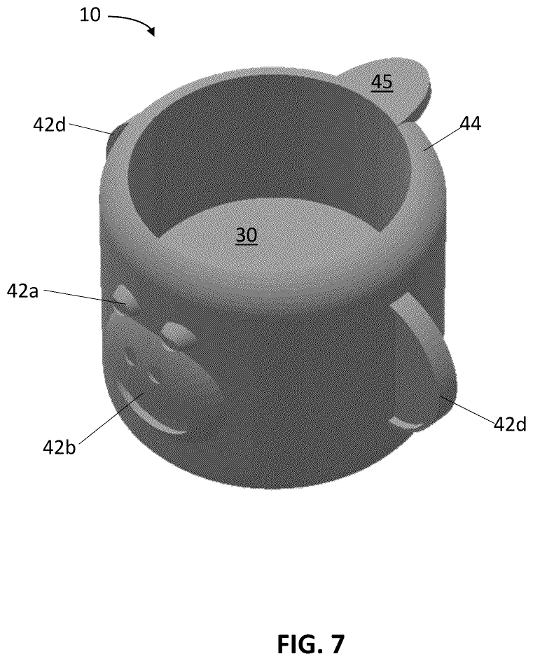

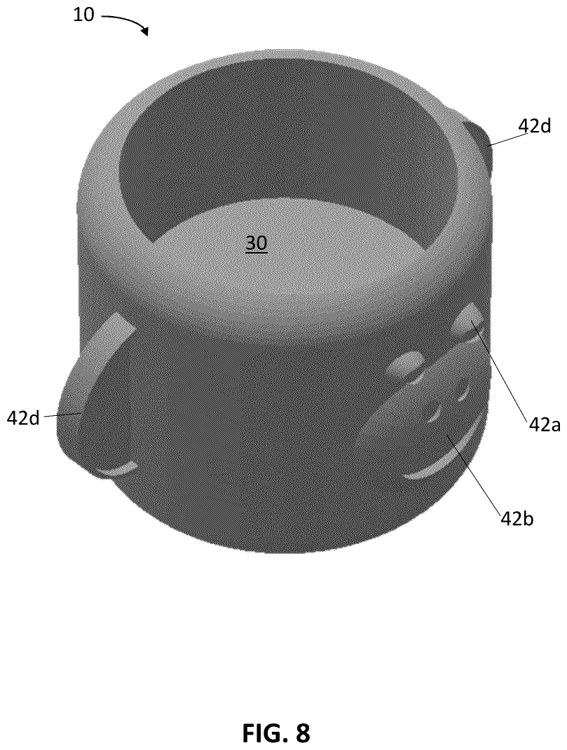

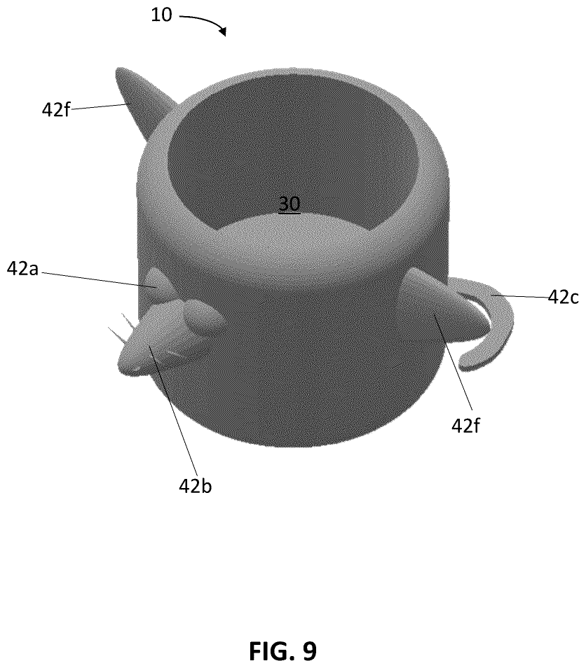

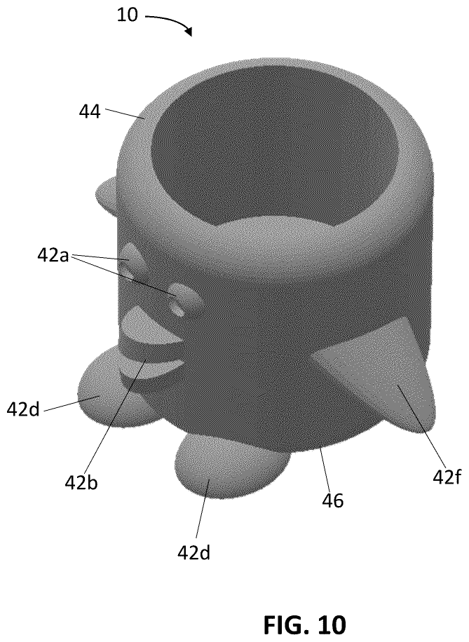

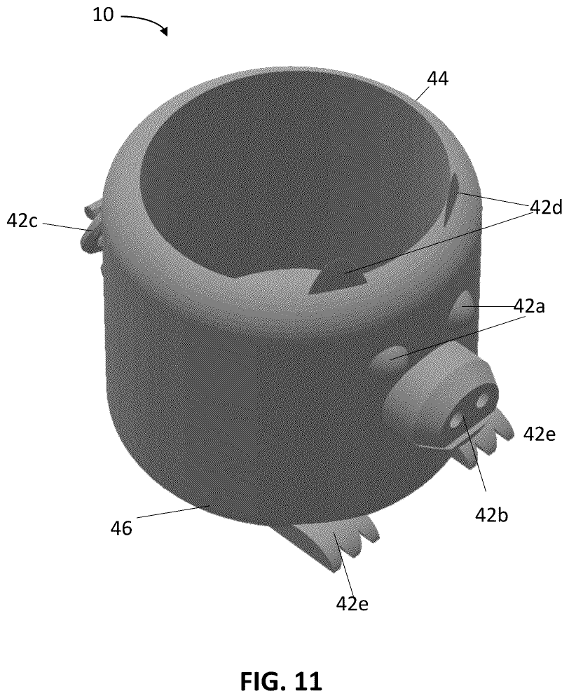

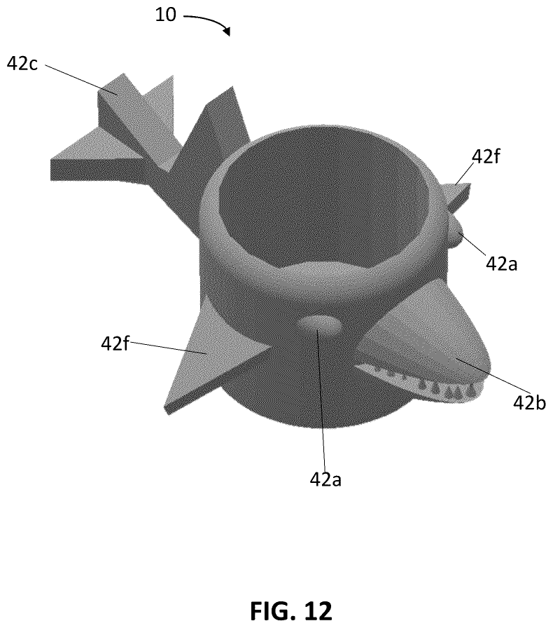

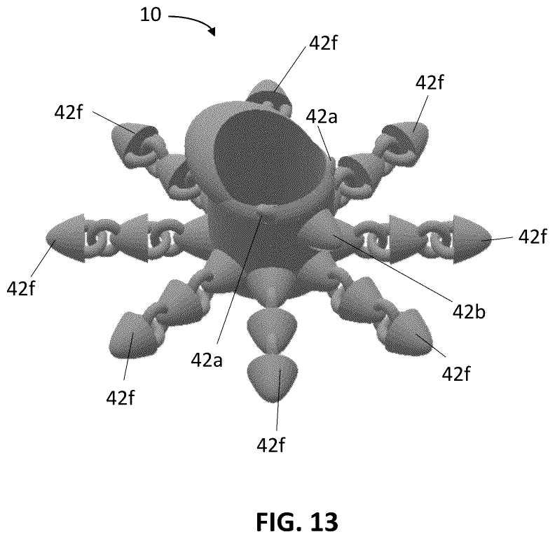

FIGS. 1-13 illustrate medicine dispenser apparatus 10 having one or more structural components 42 proximately locate the outer circumference 40 and configured in various toy-like figure appearances. While the figures illustrate the toy-like appearance configured to be an animal, the toy-like appearance could have other configurations, such as a car, doll, cartoon figurine, animated movie character, and the like, without departing from the spirit of the present invention. For exemplary purposes shown in the figures, the toy-like appearance can be configured as an animal, including a bird (FIGS. 1A-1B), a rabbit (FIG. 2), a cat (FIG. 3), a dinosaur (FIG. 4), a dog (FIG. 5), a duck (FIG. 6), a monkey (FIGS. 7-8), a mouse (FIG. 9), a penguin (FIG. 10), a pig (FIG. 11), a shark (FIG. 12), and an octopus (FIG. 13). While various toy-like figure appearances have been specifically illustrated herein, other toy-like figure appearances are also contemplated by the present disclosure, including other animals, vehicles (trucks, cars, planes, trains, etc.), and the like. Further, the various views of each medicine dispensing apparatus 10 are provided to illustrate that structural components 42 can have various shapes and sizes to provide the desired toy-like appearance on the outer circumference 40.

In some preferred aspects, medicine dispensing apparatus 10 has at least one structural component 42 providing for a face-like appearance of an animal. In some preferred aspects, medicine dispensing apparatus 10 has at least two structural components 42a providing for eyes of the face-like appearance of the animal. In some aspects, the at least two structural components 42a providing for eyes are proximately located the top peripheral edge 44. In some preferred aspects, medicine dispensing apparatus 10 has at least two structural components 42a providing for eyes and at least one structural component 42b providing for a nose, beak, snout, mouth or the like of the face-like appearance of the animal. In some preferred aspects, the at least two structural components 42a providing for eyes are proximately located above the at least one structural component 42b providing for the nose, beak, snout, or the like of the face-like appearance of the animal.

In some preferred aspects, medicine dispensing apparatus 10 has at least one structural component 42c providing for a tail-like appearance of an animal. In some aspects, the at least one structural component 42c providing for the tail-like appearance of the animal is proximately located an opposite circumferential side than the at least one structural component 42 providing the face-like appearance of the animal. In some other aspects, the at least one structural component 42c providing for the tail-like appearance of the animal is proximately located a bottom peripheral edge 46 and on an opposite circumferential side than the at least one structural component 42 providing the face-like appearance of the animal.

In some preferred aspects, medicine dispensing apparatus 10 has at least two structural components 42d providing for an ear-like appearance of an animal. In some aspects, the at least two structural components 42d providing for the ear-like appearance of the animal are proximately located above the at least one structural component 42 providing the face-like appearance of the animal. In some aspects, the at least two structural components 42d providing for the ear-like appearance of the animal are proximately located the same circumferential side and above the at least one structural component 42 providing the face-like appearance of the animal. In some aspects, the at least two structural components 42d providing for the ear-like appearance of the animal are proximately located a portion of the top peripheral edge 44 of the outer circumferential surface 40. In some aspects, the at least two structural components 42d providing for the ear-like appearance of the animal are proximately located the same circumferential side as the at least one structural component 42 providing the face-like appearance and on a portion of the top peripheral edge 44 of the outer circumferential surface 40. In some other aspects, the at least two structural components 42d providing for the ear-like appearance of the animal are proximately located on opposing circumferential sides of the cup.

In some preferred aspects, medicine dispensing apparatus 10 has at least two structural components 42e providing for a feet-like appearance of an animal. In some aspects, the at least two structural components 42e providing for the feet-like appearance of the animal are proximately located below the at least one structural component 42 providing the face-like appearance of the animal. In some aspects, the at least two structural components 42e providing for the feet-like appearance of the animal are proximately located the same circumferential side and below the at least one structural component 42 providing the face-like appearance of the animal. In some aspects, the at least two structural components 42e providing for the feet-like appearance of the animal are proximately located a portion of the bottom peripheral edge 46 of the outer circumferential surface 40. In some aspects, the at least two structural components 42e providing for the feet-like appearance of the animal are proximately located the same circumferential side as the at least one structural component 42 providing the face-like appearance and on a portion of the bottom peripheral edge 46 of the outer circumferential surface 40.

In some preferred aspects, medicine dispensing apparatus 10 has at least two structural components 42f providing for a fin-like, a wing-like, a leg-like or an arm-like appearance of an animal. In some aspects, the at least two structural components 42f providing for the fin-like, the wing-like, the leg-like or the arm-like appearance of the animal are proximately located on opposing circumferential sides of the cup. In some aspects, the at least two structural components 42f providing for the leg-like or the arm-like appearance of the animal are proximately located on the bottom peripheral edge 46.

One of ordinary skill in the art will appreciate that the foregoing structural components 42 are illustrated in the various figures without the reference numerals shown in each and every respective view. One of ordinary skill in the art will also appreciate that the quantity of structural components 42 may vary depending upon the particular toy-like appearance, and the various structural components 42 may comprise various shapes and sizes to provide the desired toy-like appearance on the outer circumference 40.

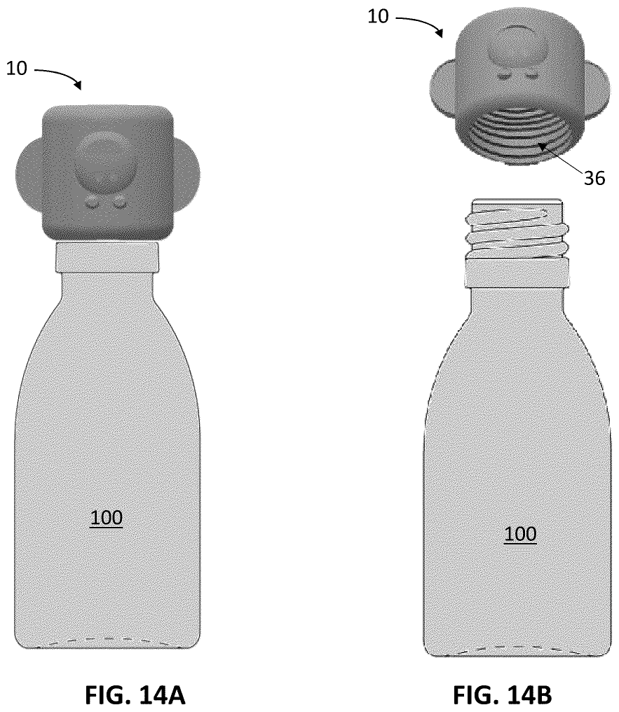

Referring now to FIGS. 14A-14B, 17 and 18, in some preferred embodiments, medicine dispenser apparatus 10 has threads 32 on at least a portion of the internal circumferential surface 35 of the cup 20, such that medicine dispenser apparatus 10 can also function as a cap for a container 100. In some preferred aspects, medicine dispenser apparatus 10 functions as a cap for a liquid medicine container 100.

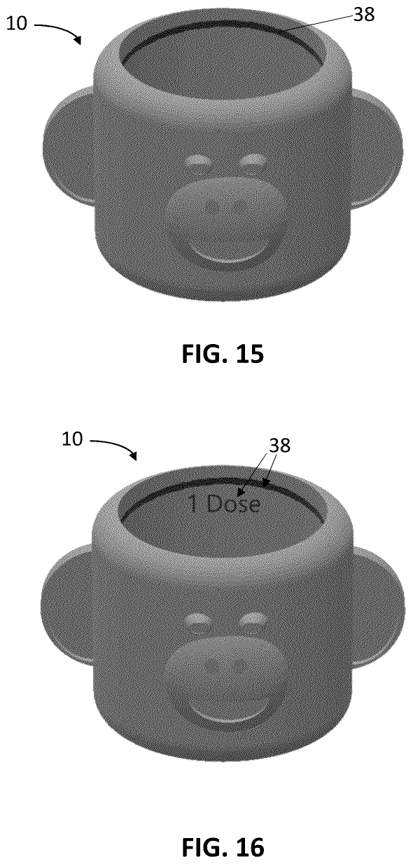

Referring now to FIGS. 15-18, in some preferred embodiments, medicine dispenser apparatus 10 has at least one dosing indicator 38. Dosing indicator 38 may be a solid line, such as shown in FIGS. 15-17, which is preferably provided at a pre-measured volume. Alternatively, the dosing indicator 38 may be a dotted line, symbol, or other indicator of a pre-determined volume. Dosing indicator 38 preferably provides a visual indicator of a pre-determined volume between about 0.5 mL and 15 mL, preferably between about 1.25 mL and 15 mL. In some preferred aspects, medicine dispenser apparatus 10 has two or more dosing indicators 38, such that medicine dispenser apparatus 10 has two or more visual indicators of pre-measured volumes between about 1.25 mL and 15 mL. As shown in FIG. 16, medicine dispenser apparatus 10 can have two or more different dosing indicators 38, such as a visual indicator denoting a pre-measured volume, such as a line or symbol, and a written indicator of the respective pre-measured volume. While FIG. 16 provides a written indicator as “1 Dose”, one of ordinary skill will appreciate that the written indicator can take various forms or wordings, such as “1 mL”, “5 milliliters,” “1.5 milliliters,” “2 milliliters,” and the like.

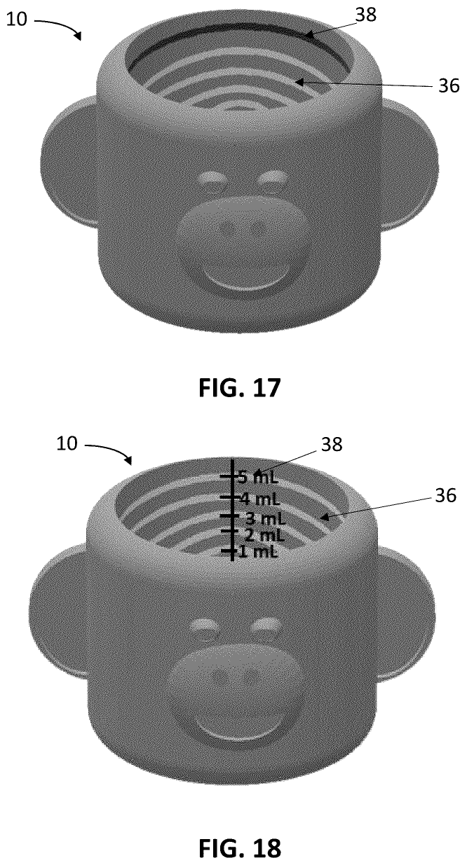

In a preferred embodiment, such as shown in FIG. 17, medicine dispenser apparatus 10 can have threads 32 and at least one dosing indicator 38.

In a preferred embodiment, such as shown in FIG. 18, medicine dispenser apparatus 10 can have threads 32 and two or more dosing indicators 38, each dosing indicator 38 identifying a different pre-measured volume. In some aspects, the two or more dosing indicators 38 may be provided on one internal circumferential surface 35. In some other aspects, the two or more dosing indicators 38 may be provided on more than one internal circumferential surface 35.

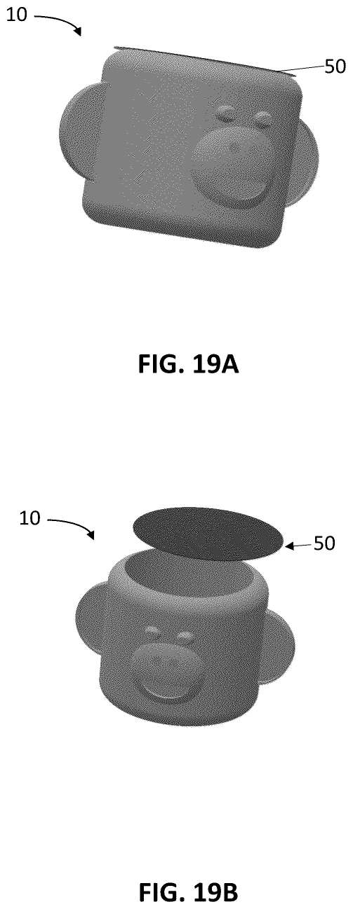

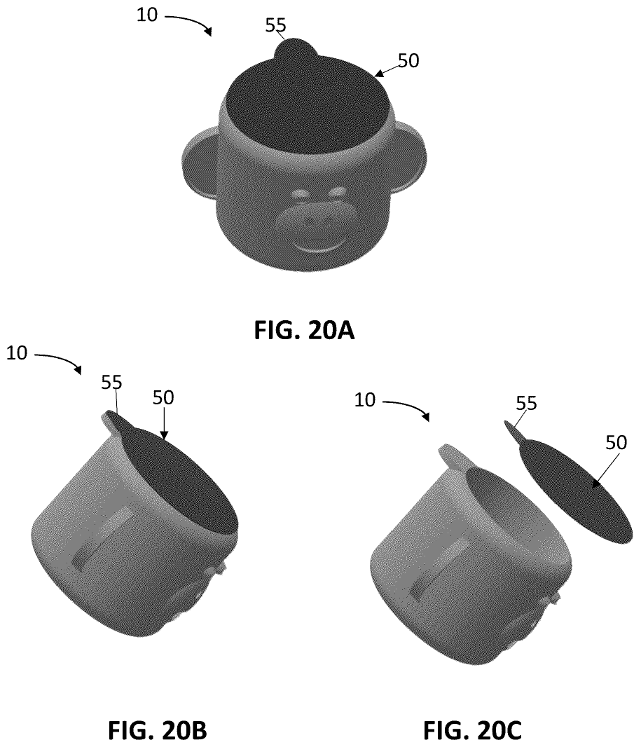

In a preferred embodiment, such as shown in FIGS. 19A-20C, medicine dispenser apparatus 10 may contain a sealed dose of material, preferably a liquid, more preferably a liquid medicine, within the interior volume 30 of cup 20. In some aspects, the material is sealed within the interior volume 30 of cup 20 by a seal 50 on the top peripheral edge 44 of cup 20. In some aspects, as shown in FIGS. 19A, at least a portion of the seal 50 overlaps the top peripheral edge 44, such that a user can peal the seal 50 from the top peripheral edge 44 of cup 20 to dispense of the material, preferably a liquid medicine. In some other preferred aspects, seal 50 contains at least one tab portion 55 that is not sealed to the top peripheral edge of the cup, such that a user can employ the tab portion 55 to peal seal 50 from the top peripheral edge 44 of cup to dispense the medicine.

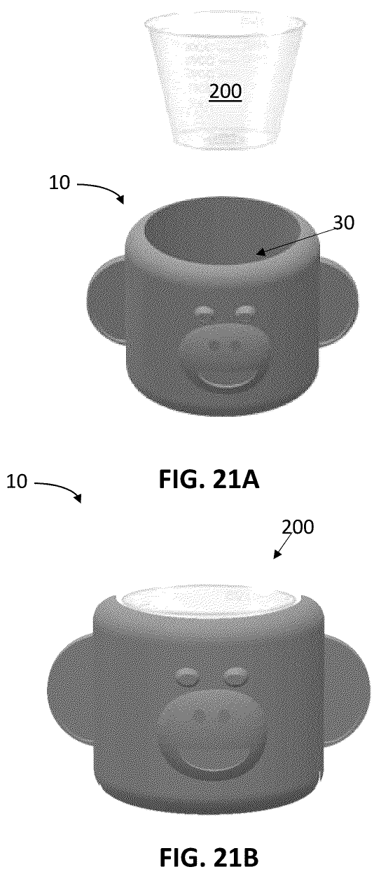

In another preferred embodiment, as shown in FIGS. 21A and 21B, medicine dispenser apparatus 10 can be configured to have an interior volume 30 of cup 20 that is capable of receiving a medicine cup 200, such that the medicine cup 200 can contain the medicine, preferably liquid medicine. In some aspects, medicine cup 200 can be operably inserted into interior volume 30 of medicine dispenser apparatus 10 prior to the medicine being dispensed to a person. In some aspects, medicine cup 200 can be operably removed from interior volume 30 of medicine dispenser apparatus 10 after the medicine is dispensed to a person.

The present disclosure is also directed at a method of dispensing medicine, preferably liquid medicine, to a person, preferably a child, utilizing the medicine dispenser apparatus 10 disclosed herein. The method comprises providing a medicine dispenser apparatus 10, providing medicine within interior volume 30, and dispensing medicine out of the interior volume 30. In some aspects, medicine is provided directly within interior volume 30. In some alternative aspects, medicine is provided within separate medicine cup 200, which can be placed within interior volume 30 before medicine is provided within separate medicine cup 200 or after medicine is previously provided within separate medicine cup 200. In preferred aspects, the medicine is a liquid medicine. In other preferred aspects, the medicine is a powder, capsule or pill.

In some aspects, the person to whom the medicine is to be dispensed is allowed to play with medicine dispenser apparatus 10 prior to medicine being provided within interior volume 30, such that the person becomes familiar with the toy-like appearance and views medicine dispenser apparatus 10 in a non-threatening manner. In some other aspects, the medicine is dispensed within interior volume 30 prior to medicine dispenser apparatus 10 being provided to the end-user recipient.

In some aspects, the person to whom the medicine is to be dispensed is allowed to drink a liquid from medicine dispenser apparatus 10 prior to medicine being provided within interior volume 30, such as juice, milk or water, such that the person becomes familiar with the toy-like appearance and views medicine dispenser apparatus 10 in a non-threatening manner.

In some aspects, the person to whom the medicine is to be dispensed is allowed to play with medicine dispenser apparatus 10 after medicine is provided within interior volume 30 and dispensed out of interior volume 30, such that the person becomes familiar with the toy-like appearance and views medicine dispenser apparatus 10 in a non-threatening manner.

In some aspects, medicine dispenser apparatus 10 is able to function as both an apparatus for dispensing medicine and a toy to a child.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A medicine dispenser apparatus comprising:
a container configured in the form of a cup having an interior volume and an outer circumferential surface area, wherein the interior volume is capable of containing at least one dose of medicine, wherein the outer circumferential surface area comprises a top peripheral edge, a bottom peripheral edge, and an intermediate surface area proximately located between the top and bottom peripheral edges, and wherein the outer circumferential surface area comprises one or more structural components providing a toy-like figure appearance on the outer circumferential surface area of the cup, such that the toy-like figure appearance is capable of alleviating a recipient's concern in dispensing the dose of medicine.

2. The medicine dispenser apparatus of claim 1, wherein the interior volume is configured to contain the medicine in the form of a liquid, powder, pill or capsule.

3. The medicine dispenser apparatus of claim 1, wherein the one or more structural components proximately located the top peripheral edge.

4. The medicine dispenser apparatus of claim 4, wherein the one or more structural components having the shape and size configured as an ear to provide an ear-like appearance.

5. The medicine dispenser apparatus of claim 1, wherein the one or more structural components proximately located the bottom peripheral edge.

6. The medicine dispenser apparatus of claim 5, wherein the one or more structural components having the shape and size configured as a foot to provide a foot-like appearance.

7. The medicine dispenser apparatus of claim 1, wherein the one or more structural components proximately located the intermediate surface area.

8. The medicine dispenser apparatus of claim 7, wherein the one or more structural components having the shape and size configured as a body part chosen from an eye, a nose, a beak, a snout, a mouth, an ear, a foot, a fin, a wing, a leg, an arm, and a tail.

9. The medicine dispenser apparatus of claim 1, wherein the one or more structural components having the shape and size configured as a body part chosen from an ear, a foot, an eye, a nose, a beak, a snout, a mouth, an ear, a foot, a fin, a wing, a leg, an arm, and a tail.

10. The medicine dispenser apparatus of claim 1, comprising two or more structural components having the shape and size configured as a body part chosen from an ear, a foot, an eye, a nose, a beak, a snout, a mouth, an ear, a foot, a fin, a wing, a leg, an arm, and a tail.

11. The medicine dispenser apparatus of claim 1, comprising a first structural component proximately located the intermediate surface area and having the shape and size configured as a body part chosen from an ear, a foot, a nose, a beak, a snout, a mouth, an ear, a fin, a wing, an arm, and a tail., and a second structural component proximately the top peripheral edge having the shape and size configured as an eye or the bottom peripheral edge having the shape and size configured as a foot or a leg.

12. The medicine dispenser apparatus of claim 11, wherein the toy-like figure appearance comprises an animal chosen from a bird, a rabbit, a cat, a dinosaur, a dog, a duck, a monkey, a mouse, a penguin, a pig, a cow, a horse, a goat, a chicken, a fish, a shark, an octopus, a zebra, an elephant, a bee, a lady bug, and a giraffe.

13. The medicine dispenser apparatus of claim 1, wherein the one or more structural components comprises a first set of structural components having the shape and size configured as a pair of eyes.

14. The medicine dispenser apparatus of claim 13, wherein the one or more structural components comprises a second set of structural components having the shape and size configured as a body part chosen from one or more ears, one or more feet, a nose, a beak, a snout, a mouth, one or more fins, one or more wings, one or more legs, one or more arms, and a tail.

15. The medicine dispenser apparatus of claim 1, wherein the one or more structural components comprises a first set of structural components having the shape and size configured to provide a first body area and a second set of structural components having the shape and size configured to provide a second body area.

16. The medicine dispenser apparatus of claim 15, wherein the first body area is a facial area comprising at least one of a pair of eyes and a nose, a beak, a snout or a mouth, and wherein the second body area is a limb area comprising a tail, one or more arms, one or more feet, one or more legs, one or more fins, one or more wings, or one or more ears.

17. The medicine dispenser apparatus of claim 1, wherein the medicine dispenser apparatus comprises threads on at least a portion of the internal circumferential surface area of the cup, such that medicine dispenser apparatus is configured to operably couple as a with a container.

18. The medicine dispenser apparatus of claim 1, wherein the medicine dispenser apparatus further comprises at least one dosing indicator of a pre-determined volume, the at least one dosing indicator chosen from a solid line, dotted line, symbol, written words, or a combination thereof, and wherein the pre-determined volume being between about 0.5 mL and 15 mL.

19. The medicine dispenser apparatus of claim 1, wherein the medicine dispenser apparatus further comprises a seal operably coupled to the top peripheral edge, wherein a sealed dose of material is contained within the interior volume.

20. A method of dispensing the at least one dose of medicine to a recipient with the medicine dispenser apparatus having the toy-like appearance of claim 1, the method comprising:
providing the medicine dispenser apparatus having the toy-like appearance to the recipient;
dispensing the at least one dose of medicine into an inner volume of the apparatus; and
dispending the at least one dose of medicine out of the inner volume of the apparatus to the recipient.
